(19) United States
(12) Patent Application Publication
(10) Pub. No.: US 2021/0362261 A1
(43) Pub. Date: Nov. 25, 2021

(54) PIPELINE HANDLER WITH WELDER

(71) Applicant: CRC-EVANS PIPELINE INTERNATIONAL, INC., Houston, TX (US)

(72) Inventors: Timothy J. BOND, Cypress, TX (US); Jose C. BOUCHE, Tomball, TX (US); Duncan CHAPMAN, Houston, TX (US); Jason W. CURBO, Weston Lakes, TX (US); Kunjan M. DEDHIA, Richmond, TX (US); Alan JONES, Bellaire, TX (US); Siddharth MALLICK, Spring, TX (US); Dan MOERS, Houston, TX (US); Shailesh RADHAKRISHNAN, The Woodlands, TX (US); Travis W. SMITH, The Woodlands, TX (US)

(21) Appl. No.: 17/220,287

(22) Filed: Apr. 1, 2021

Related U.S. Application Data
(60) Provisional application No. 62/704,656, filed on May 20, 2020.
(60) Provisional application No. 62/704,732, filed on May 26, 2020.

(51) Int. Cl. B23K 9/095; B23K 37/053

(52) U.S. Cl. CPC B23K 9/0956; B23K 2101/06; B23K 37/0533

(57) ABSTRACT

Provided is a weld assembly supported from an arm of a heavy equipment vehicle. The vehicle includes a pipe grabber for manipulating the position of a pipe. The weld assembly integrated with and supported from the manipulator. The weld assembly further includes a conforming ring, a sensor assembly and an orbital welder. The weld assembly is also of a clam shell construction for wrapping around two pipe ends to be welded.

### CROSS-REFERENCE TO RELATED APPLICATIONS

This non-provisional application claims the benefit of U.S. provisional application 62/704,656 filed May 20, 2020 and U.S. provisional application 62/704,732 filed May 26, 2020. Both applications disclose orbital welding machines with features that may be interchangeable. Furthermore, priority from both U.S. Provisional Application No. 62/704,656 and U.S. Provisional Application No. 62/704,732 are incorporated herein by reference in their entirety.

### BACKGROUND OF THE INVENTION

The present invention relates to an apparatus for positioning and welding pipes, particularly, a hydraulically pipe handler for positioning two pipe ends to be joined (e.g. by welding) and a welder supported by the handler.

Typically, during construction of a pipeline, pipe segments are laid on the ground end to end. The laid pipe may also be laid parallel with and adjacent to a ditch into which the finished pipeline is to be buried. Conventional methods of positioning/aligning the ends of two pipe segments in preparation for welding will typical include one or more lifters/cranes with straps for support ends of the pipe segments. The lifter hoists the pipes allowing a worker to manually pivot the ends into close proximity. After the pipe ends are sufficiently aligned, a mechanical clamp may be secured around an exterior portion of the gap straddling the gap to hold the pipe in place.

It would be beneficial to instead provide a lifter with multiple hydraulic claws or grabbers which could grab adjacent respective pipe segment ends and force/manipulate them into alignment. It would also be beneficial to provide a deformation ring which includes radially inwardly directed hydraulic shoes for positioning and/or shaping the pipe ends. It would also be beneficial to provide a welder mounted to the deformation ring and/or grabber which could surround and embrace the pipe ends (e.g., pipe gap or interface) in the same or similar manner (e.g., clam shell) as the grabbers to weld the two pipes together. Such an all in one system would promote efficiency and safety by eliminating the need for workers to perform certain aligning welding operations in a confined trench.

A number of patents discuss topics generally related to the subject matter described above. For Example, U.S. Pat. Nos. 8,328,071; 8,590,769; 9,073,732; 9,452,497; 10,226,842, 8,973,244 and 10,344,892 each teach a grabber with an integrated welder. Each of the foregoing patents are also incorporated herein in their entirety by reference.

When the welder is mounted at the gap between the two pipe segments, it is able to perform a 360° weld while the grabber is maintaining an acceptable relative pipe positioning.

### SUMMARY OF THE INVENTION

According to one aspect of the invention is provided a grapple welding machine including a pipe positioner and a welder for surrounding clutching, securing and manipulating a position of ends of pipes to be welded and welding the ends together. The pipe positioner including a pair of grapples mounted on a main beam. The grapples grab and securing a pipe. The welder also includes a welding bug having a torch. The torch may ride on a bug rail on which the welding bug is guided. The welder may also include a deformation ring and a sensor. The deformation ring may include radially extending shoes which forcefully engage an outer surface of a pipe to be welded. The sensor may include at least one radially inward directed sensor connected to a mount on the welder. The welding bug may be rollably connected to the bug rail and traverse the bug rail in a parallel arc with the welding area. The deformation ring and sensor may also include at least one pivotable clamshell structure for selectively surrounding the pipe. Furthermore, the welder may be mounted to the pipe positioner and the clamshell structure may be openable in concert with the grapples to receive the pipe ends and closable after closing of the grapples to surround a weld region of the pipe.

### BRIEF DESCRIPTION OF THE DRAWINGS

FIG. 1A is a top perspective view of a prior art heavy equipment vehicle of the present invention grasping two pipe ends to be welded.

FIG. 1B is top perspective view of a prior art gripper and welder in an open configuration.

FIG. 1C is a top perspective view of the prior art welder of FIG. 1 in closed a configuration.

FIG. 2A is a top perspective view of a gripper of the present invention.

FIG. 2B is a top perspective view of the gripper of FIG. 2A with a weld assembly of the present invention thereon.

FIG. 3A is a top perspective view of the weld assembly of FIG. 2B including a retracted sensing ring.

FIG. 3B is a top perspective view of the weld assembly of FIG. 2B including an extended sensing ring.

FIG. 4A shows a rear upper perspective view of the deformation ring of FIG. 2B.

FIG. 4B shows a front upper perspective view of the deformation ring of FIG. 2A.

FIG. 5A shows an enlarged view of a deformation ring of the welder of FIG. 2B showing a welding rail of a welding bug.

FIG. 5B shows an enlarged view of the welding rail of FIG. 5A. illustrating details of the rail.

FIG. 6A is an upper rear perspective view of the welding bug of FIG. 3B.

FIG. 6B shows an upper front perspective view of the welding bug of FIG. 3A.

FIG. 6C shows details of a drive wheel of the welding bug of FIGS. 3A and 3B.

FIG. 7A shows a side view of a sensing ring of FIG. 3A.

FIG. 7B shows an exploded inside view of a portion of the sensing ring of FIG. 7A with distance sensors thereon.

FIG. 8 shows an exemplary weld bug of the weld bugs of FIG. 7B with a torch in both holders.

FIG. 9 shows a perspective view of an arrangement of weld equipment including a grasshopper for use with the weld bug of FIG. 7B.

FIG. 10 illustrates an enlarged view of the grasshopper of FIG. 11 showing further details.

FIG. 11 shows the grasshopper of FIG. 11 with a first arm in the upward electrically disengaged position and a second in the engaged position.

FIG. 12 shows the grasshopper of FIG. 11 with a second arm in the upward electrically disengaged position and a first in the engaged position.

FIG. 13 shows the grasshopper of FIG. 11 with actuators for automatically changing between the configurations of FIG. 13 and FIG. 14.

FIGS. 14A-14F illustrate an exemplary operational sequence of weld bug and grasshopper configurations and directions.

FIG. 15 shows a flow chart of one possible sequence of pipe manipulation operations.

### DETAILED DESCRIPTION OF THE PREFERRED EMBODIMENTS

Vehicle Mounted Manipulative Welder

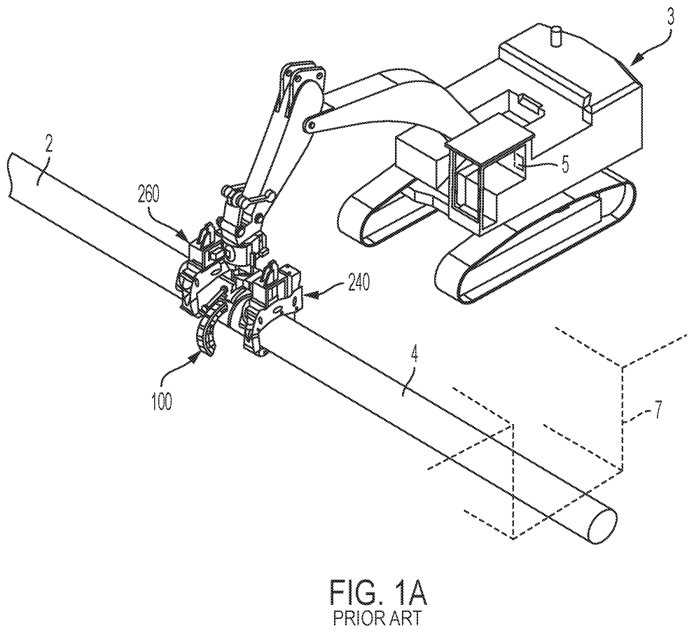

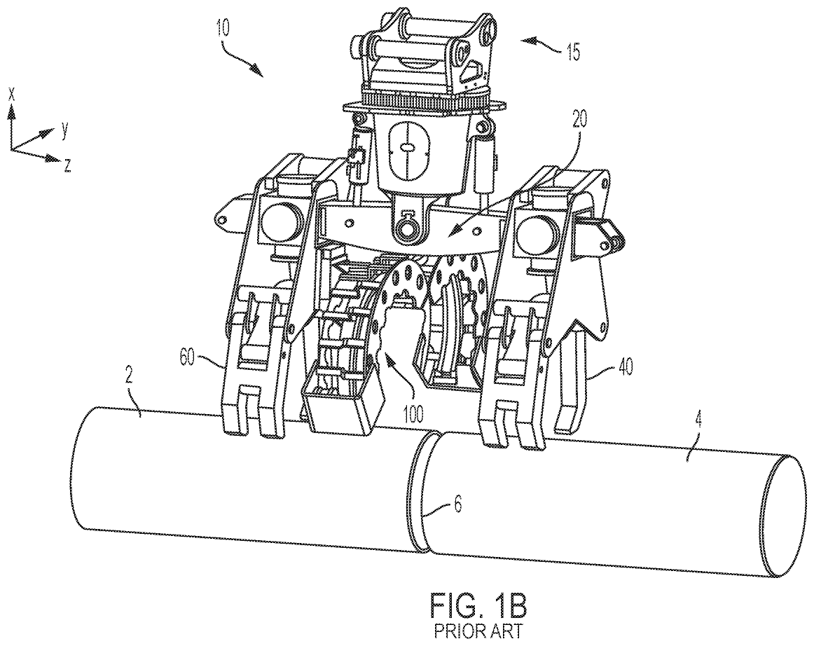

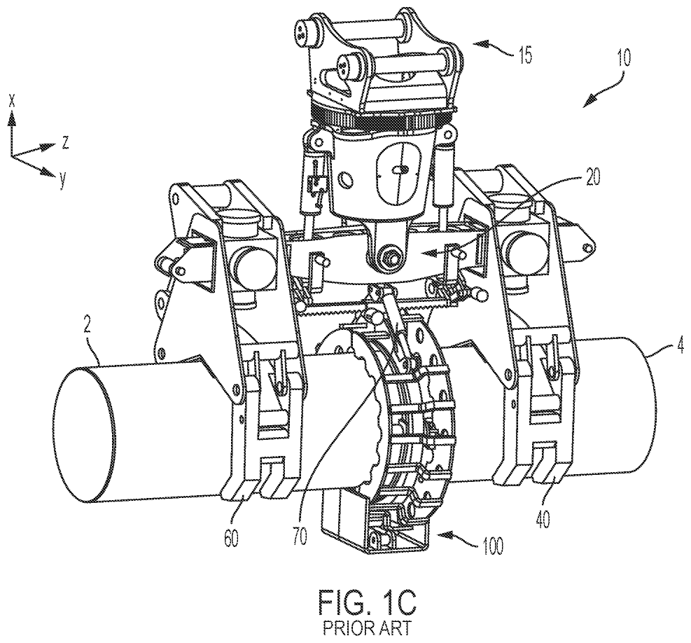

FIG. 1A shows a heavy equipment vehicle 3 at an edge of a trench 7. FIG. 1B shows a grapple welder 10 of the prior art. Grapple welder 10 may be connected to and manipulated by an arm a hydraulic lifter (not shown). The connection between grapple welder 10 and the arm is via the grapple welder's grapple connector 15. FIG. 1B shows that connected to grapple connector 15 is a main beam 20. Moveably connected to main beam 20 are grapples 40 and 60. Grapples 40 and 60 may move relative to main beam 20 at least based on the degrees of freedom disclosed in U.S. Patent Numbers already incorporated above. Grapples 40 and 60 are pivotable claw-like clamshell-type pivot grabbers which open to accept a pipe 2 and/or 4, and close to engage and grab pipes 2 and/or 4. Pipes 2 and 4 are held together by grapple welder 10 and manipulated so that ends of pipes 2 and 4 form a weld gap 6. FIG. 1B also shows a weld assembly 100 in an open configuration connected to grapple welder 10. In the open configuration shown in FIG. 1 B, weld assembly 100 may open to receive pipes 2, 4 in a similar way as grapples 40, 60 open. On the other hand, FIG. 1C shows weld assembly 100 in the closed position wrapped around pipes 2 and 4 such that it radially covers and longitudinally aligns with weld gap 6. When weld assembly 100 is in the closed position of FIG. 1C, grapple welder 10 is able to perform one or more weld passes at and between pipes 2 and 4 and connecting adjacent or abutting ends of pipe 2 to pipe 4. An actuator 70 may extend between weld assembly 100 and some other portion of grapple welder 10 (e.g., main beam 20) to urge weld assembly between the open and closed positions. Vehicle 3 includes a computer 5 having a display and connectivity enabling wired or wireless data communication between the computer and weld assembly 100 so that the operator of vehicle 3 may monitor weld operations.

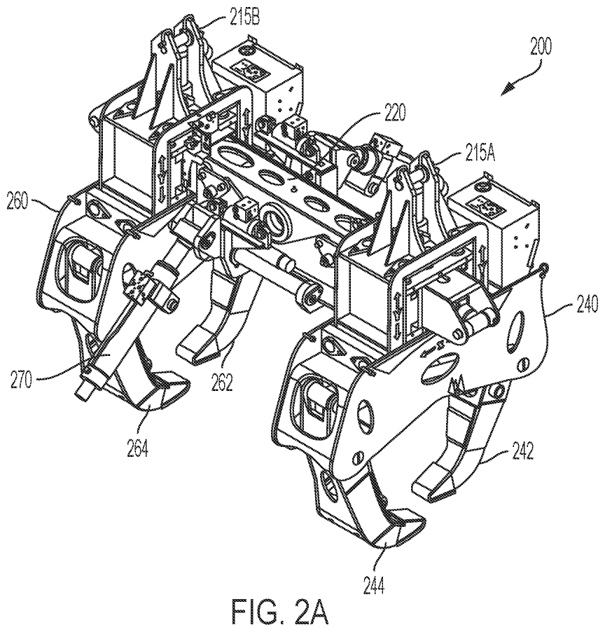

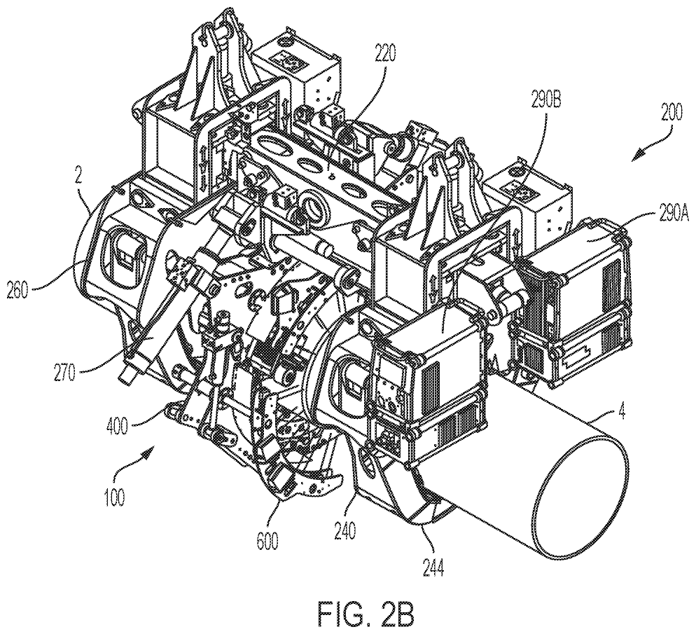

FIG. 2A shows a top perspective view of a manipulator 200 of the present invention for manipulating ends of pipes. Manipulator 200 of FIG. 2A generally corresponds to the prior art grapple welder 10 of FIGS. 1A, 1B, and 1B except for the weld assembly 100 thereof. Similarly, manipulator 200 includes a main beam 220 and grapples 240 and 260 used for the same purpose as the prior art grapples 240, 260. Furthermore, manipulator 200 may be connected to an arm of a lifter (not shown) at a grapple arm connector 215. Grapples 240 and 260 each include a pair of opposed fingers 242, 244 and 262, 264 respectively. Opposed fingers 242, 244, 262, 264 engage respective ends of pipes 2 and 4 to cease ends of pipes 2 and 4 relative to grapples 240, 260.

FIG. 2B shows manipulator 200 including a weld assembly 300 connected thereto. Manipulator 200 is configured to grasp or grab ends of pipe 2, 4 as close to the respective ends of pipes 2 and 4 as possible. In other words, the closer to the ends of pipes 2 and 4 that fingers 242, 244, 262, 264 grasp pipes 2 and 4 respectively, the more control manipulator 200 will have when adjusting ends of pipe 2 and 4 relative to each other. Therefore, when weld assembly 300 has as small a width as possible grabbers on either side of the weld assembly 100 may approach each other down to the outer with of the weld assembly. Specifically, fingers 242, 244, 262, 264 can get as close to each other as possible to perform relative pipe end adjustment as efficiently, accurately and effectively as possible. In fact, in one embodiment of the present invention, an outermost width of weld assembly 100 is about 14 inches or less. Therefore, between an innermost pipe/finger engagement point of fingers 242, 244 and fingers 262, 264 is smaller less than 15 inches or less and preferably about 14 inches or less. Furthermore, a width of inner faces of fingers 242, 244 and fingers 262, 264 that face each other is about 54 inches or less. As mentioned above actuator 270 may extend between weld assembly 100 and some other portion of grapple welder 10 (e.g., main beam 20) to urge weld assembly between the open and closed positions.

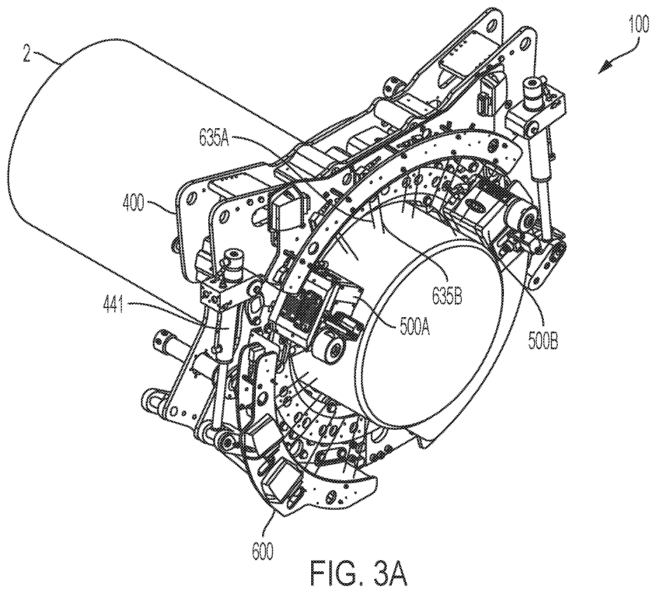

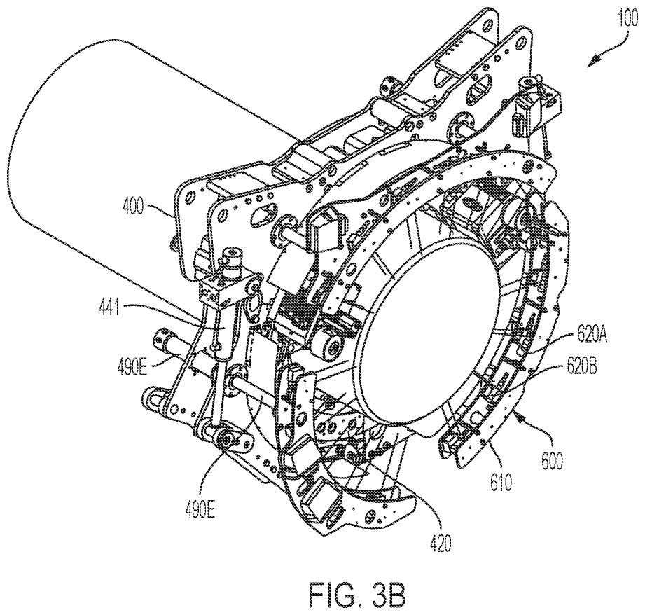

FIG. 3A and FIG. 3B show the weld assembly 300 of FIG. 2B enclosed around pipe 4 with pipe 2 and manipulator 200 removed to reveal certain interior configurations of the present invention grapple welder 10. Weld assembly 300 includes a conforming ring 400 and a sensing ring 600 (described in greater detail below).

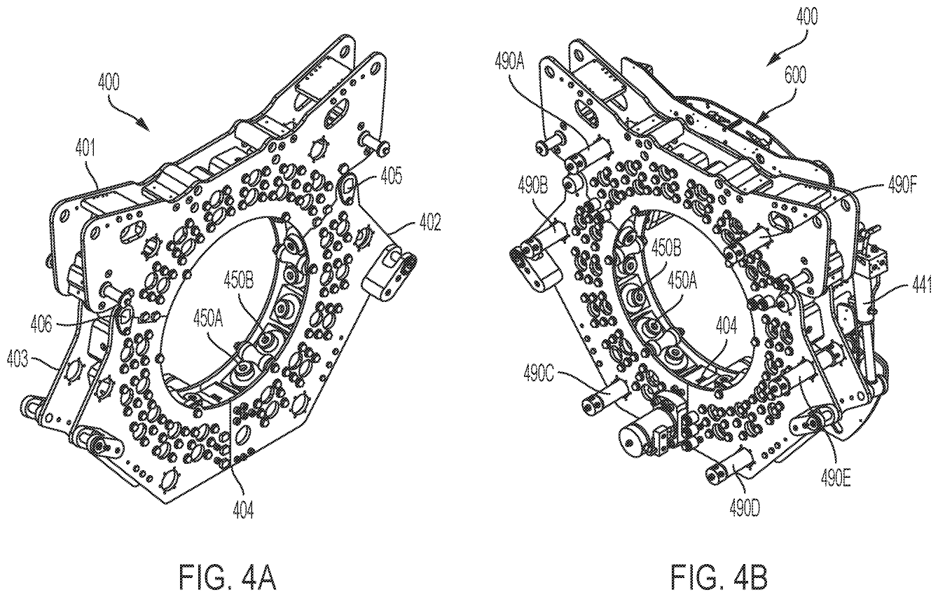

As mentioned above, the general structure of conforming ring 400 is a pivotable clamshell structure. FIG. 4A and FIG. 4B show conforming ring 400 including an upper shoulder 401 and two downward extending arcuate clamp jaws 402 and 403. In general, upper shoulder 401 may remain stationary relative to main beam 220 and clamp jaws 401 and 402 are pivotably connected to upper shoulder 401 via pivot pins 405 and 406. When conforming ring 400 takes the closed configuration shown in FIGS. 4A and 4B, conforming ring 400 comes together at seam 404. On the other hand, when conforming ring 400 is actuated by actuator 470 to transform to the open position, conforming ring 400 separates at seam 404 and two other seams at pins 405 and 406. As mentioned above actuator 270 may extend between weld assembly 100 and some other portion of grapple welder 10 (e.g., main beam 20) to urge conforming ring 400 of weld assembly 100 between the open and closed positions. Furthermore, actuator 441 may extend between conforming ring 400 and sensor assembly 600 to urge sensor 600 between the open and closed positions. An actuator 270 or 441 may be provided on both sides of weld assembly 100.

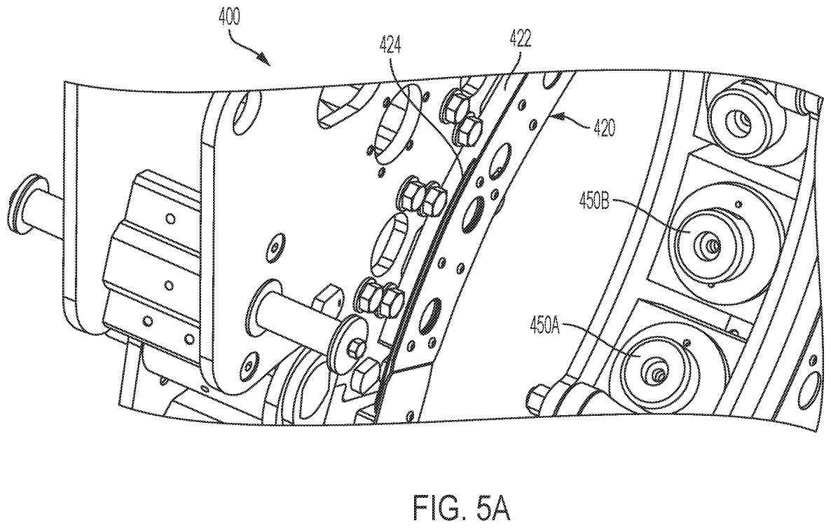

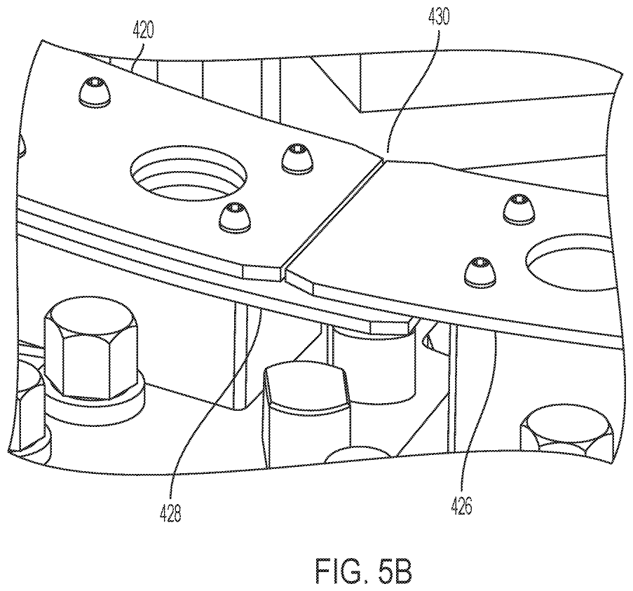

As shown in FIG. 3B, in front of and attached to conforming ring 400 is a weld bug rim 420 on or around which one or more weld bugs 500 may travel. Enlarged views of conforming ring 400 and weld bug rim 420 are shown in FIG. 5A and FIG. 5B. Weld bug rim 420 includes a first portion 422 that extends axially from conforming rim 400 and includes a second portion 424 that extends radially from first portion 422. Radially extending upper and lower edges of second portion 424 accommodate wheels of weld bug 500.

As conforming ring 400 transforms between open and closed positions to receive ends of pipes 2 and 4, weld bug rim 420 also has to take multiple configurations. In other words, weld bug rim 420 has to be able to separate and be re-joined accurately and reliably so that weld bug 500 can have a precise travel path during welding. To ensure such accuracy, the present invention may employ a double track in certain areas along the circumference second portion 424 of weld bug rim 420. For example, in the portions of second portion 424 of rim 420 that must separate during conforming rim 400 transformation, FIG. 5B most clearly shows a stationary rim portion 428 of second portion 424. Stationary rim portion 428 does not move during transformation, so its position remains accurate/fixed despite any reconfiguration. On the other hand, portions of second portion 424 referred to now as main rim 426 which separates at seam 430 move away from and back toward each other which could possibly create a small potential for misalignment.

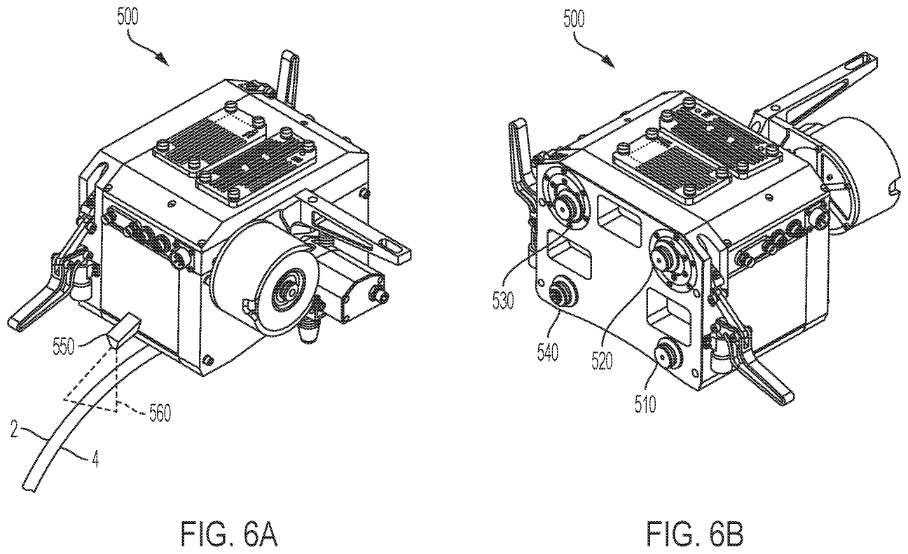

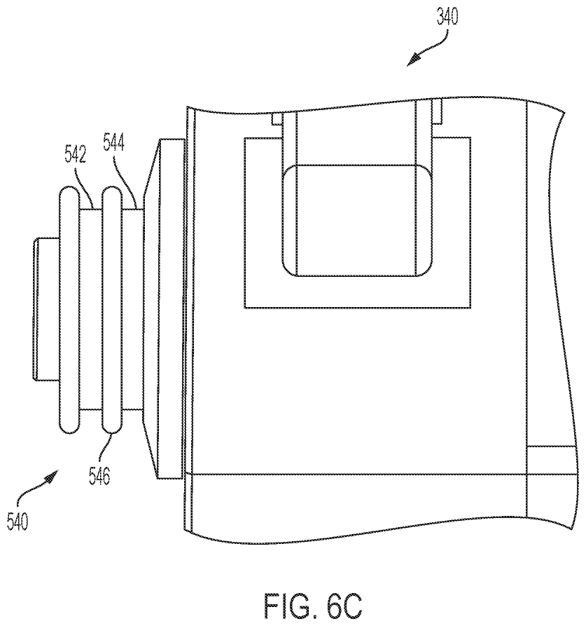

FIG. 6A shows an enlarged front view of weld bug 500 and FIG. 6B shows an enlarged rear view of weld bug 500. In the rear view, free wheeling guide wheels 510, 520, and 530 can be seen. Shown also is powered drive wheel 540. One or more of guide wheels 510, 520, 530, and powered drive wheel 540 may employ a profile which straddles both stationary rim portion 428 and main rim 426. FIG. 6C shows the double groove profile of the wheel (e.g., 540). Specifically, one or more wheels may employ a first main channel 542 and a second assurance channel 544. Channels 542 and 544 may be separated by a gap guide 546 such that the wheel travels on both guides at the same time. In other words, when conforming ring 400 is in the closed position, and at seam 430, main channel 542 rides on main rim 426 and simultaneously assurance channel 544 rides on stationary rim portion 428. That way, even if the separated ends of main rim 426 come together in less than completely accurate form, weld bug wheel (e.g., 540) via assurance channel 455 will be forced to travel in a consistent, accurate intended path.

FIG. 4A, FIG. 4B and FIG. 5A also shows a plurality of radially extending (e.g., inward) shoes 450A, 450B . . . . Shoes 450 may be positioned radially around the entire conforming ring (e.g., 24 shoes). Shoes 450 may be independently driven radially inward by the force of one or more hydraulic cylinders via a hydraulic pump until a radially innermost contact surface of a particular shoe engages an outer surface of pipe 4. After engaging one of pipes 2, 4, shoes 450 may be independently controlled to reposition a pipe end and/or deform it to conform to a desired shape.

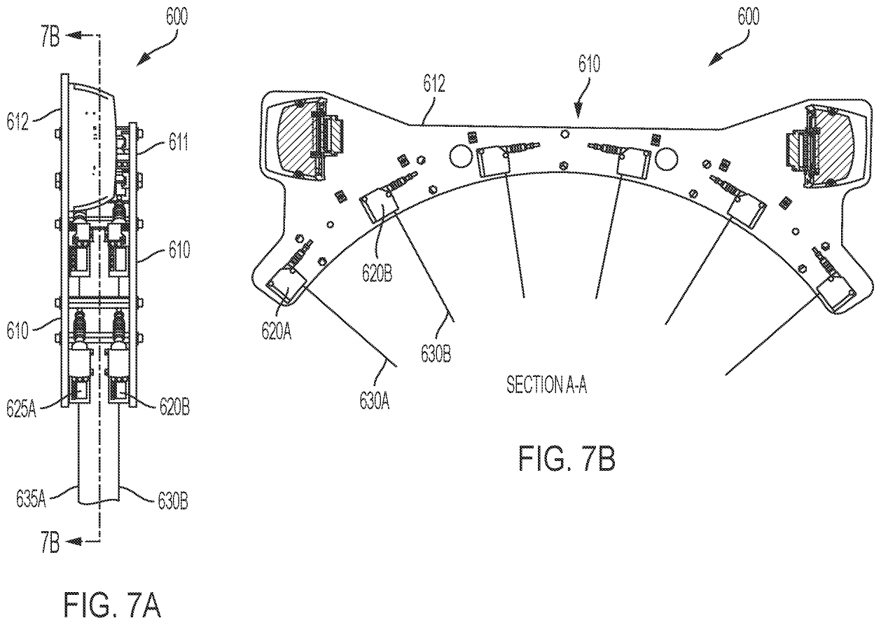

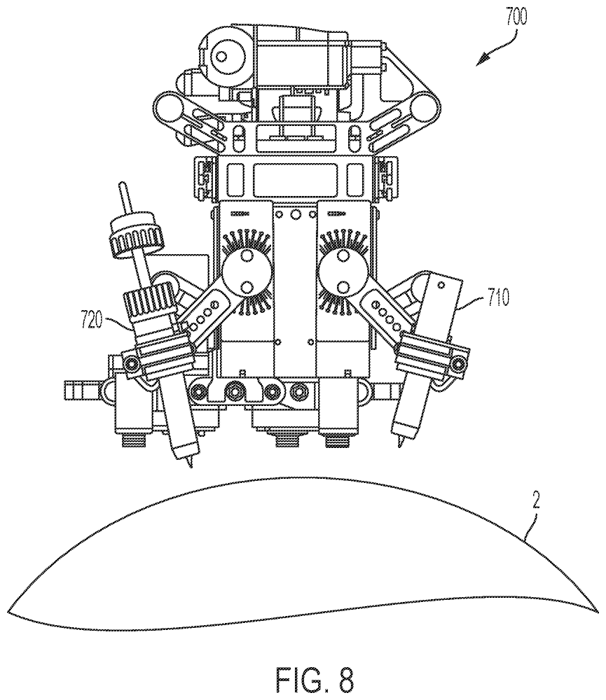

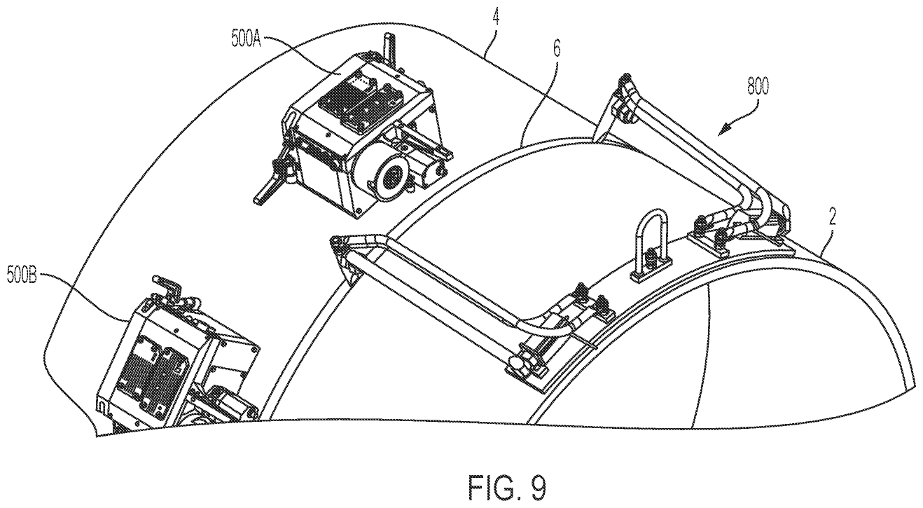

Again, and as shown in FIGS. 2B, 3A, 3B, 7A and 7B, a sensor assembly 600 extends from conforming ring 400. The purpose of sensor assembly 600 is to determine the relative circumferential position of the ends of pipes 2 and 4. In other words, the relative position at or of ends of pipes 2 and 4 are measured at various points (i.e., based on the amount of sensors) around the pipe 2, 4. Many or few sensors may be used (e.g., 24 on each side of the pipe). In one embodiment, the sensor assembly is in the form of a sensor ring 610. Sensor ring 610 is also a clamshell structure capable of surrounding pipe 4 in a similar manner to conforming ring 400. An actuation member 160 may be employed between conforming ring 400 and sensor assembly 600 to automatically open sensor assembly 600 clam shell structure. FIG. 7A shows a side view of sensing ring 610 and FIG. 7B shows an exploded view of an upper sensor shoulder 612. Individual sensors (e.g., laser distance sensors for sensing a distance to a point) are mounted to sensing ring 600 at spaced positions (e.g. equally distributed) around the pipe with the individual sensors directed radially inward toward a longitudinal axis down a center of pipes 2, 4. As shown in FIG. 7A, when sensing ring 610 is in sensing position, it employs a structure sufficiently axially wide that a first set of sensors (e.g., 620A, 620B, etc.) can be mounted a first portion 611 for direct projection onto a first pipe end (e.g., pipe 2 end). Sensing ring 610 also including a second portion 612 to which a second set of individual sensors (e.g., 625A, 625B, etc.) can be mounted for direct projection onto a second end of a pipe (e.g., pipe 4 end). Together, first portion 611 and second portion 612 allow sensing beams (e.g., 630A, 640B, etc. and 635A, 645B, etc.) to straddle an interface between ends of pipes 2 and 4 so that one set of sensors senses a position of the end of first pipe 4 and the second set of sensors senses a position of the end of second pipe 2. Sensing and recording the distance data from the individual sensors (e.g., 630A, 640B, etc. and 635A, 645B, etc.) essentially amounts to assessing/determining the shape of the end of pipe 2, 4.

Furthermore, as weld bug(s) 500A, 500B occupy a space in close proximity to the weld interface, sensor ring 600 must perform a sensing operation around weld bugs 500A, 500B without removing weld bugs 500A, 500B. Furthermore, during the welding operation, a number of cables and cords must remain tethered to weld bugs 500A, 500B and furthermore, those cords must have sufficient space to rotate around pipes 2, 4 with weld bugs 500A, 500B. Therefore, it would be beneficial if the radially outward space around weld bugs 500A, 500B, were not occupied by or in special conflict with a sensor assembly. In one embodiment, sensing ring 600 is retractable/extendable relative to conforming ring 400. FIGS. 3A and 3B show a retractable sensing ring 600. Specifically, FIG. 3A shows conforming ring 600 which includes sensors 620A, 620B which are directing distance sensing beams (e.g., 635A, 635B) radially at an outer surface of pipe 4. In FIG. 3A sensing ring 600 is retracted toward conforming ring 400 out of the way of that radial space needed for weld bug tethers and other weld operations. Sensing ring 610 may also be extended when it is time for sensing a position/shape of ends of pipes 2, 4. At that time, pistons with arms (e.g., 490A-490F shown in FIG. 4B) are connected to sensing ring 600 to extend it from conforming ring 400 out toward the weld interface until sensors are able to direct beams at and onto both ends of pipes 2, 4 near and on both sides of the weld gap 6.

In one embodiment, the sensor does not include a retractable sensing ring 600. Rather, a line sensor, senses the distances along points on a line to detect a distance profile across the interface of the weld gap 6. FIG. 6A shows a profile line sensor 550 directing a profile beam 560 at weld gap 6. Since, as shown, the line sensor 550 is mounted to weld bug 500A, 500B, line sensor can rotate around weld gap 6 collecting distance profile information to essentially form a 3-D profile of the gap on each pass layer. Such profile data could also (i.e., similar to the ability of a sensing ring with multiple individual sensors) be processed to appreciate any relative position/alignment/shape differences between ends of pipes 2 and 4.

Multi Torch Interference Solution

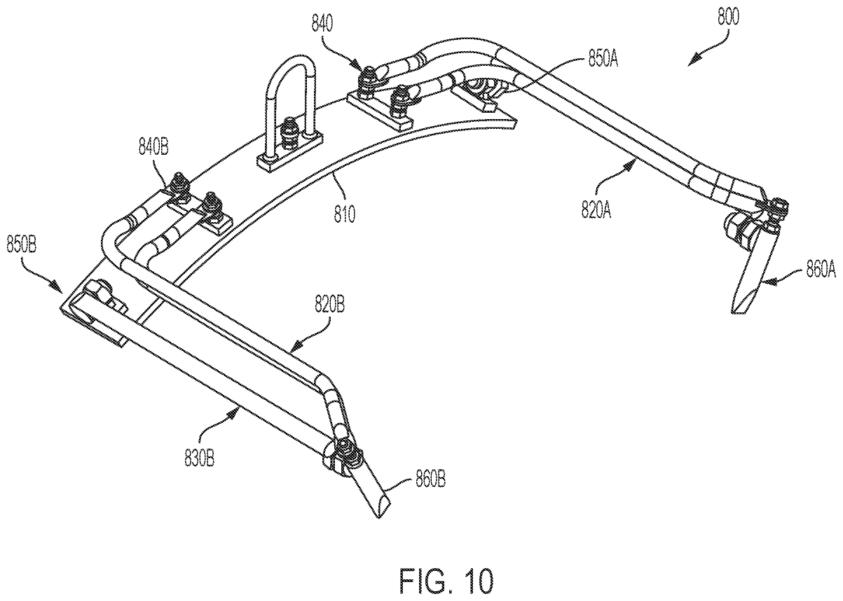

Certain orbital weld processes such as the process described above include multiple torches (e.g., two torches). FIG. 10 shows a rudimentary drawing of a cross-section of pipe 2 or 4 and weld bug 500A or 500B. Leading torch 560A extends downward from weld bug 550A in close proximity to trailing torch 560B which also extends downward with both extending toward weld gap 6. Simultaneous dual torch operation is extremely beneficial because, multiple passes may be performed with one revolution of a weld bug (e.g., 500A). Furthermore, since each torch can be run by completely independent power supplies and systems, weld passes (e.g., two passes) of different but desired character, material, etc. can be built one on top pop of the other. However, dual torch processes present certain unique challenges. When operating simultaneously, each torch process relies on its own independent sensing (e.g., supply current and supply voltage sensing) to control its respective weld process. When two torches get sufficiently close to each other, sensors of leading torch 560A may undesirably pick up or sense signals from the process of trailing torch 560B and visa versa. This cross-sensing challenge may be minimized by increasing a distance between the respective torches (i.e., 560A and 560B) and respective sensors, but such distancing may dictate a larger size weld bug 500 than desired in order to provide sufficient minimum spacing. Moreover, because two simultaneously run and independently controlled torch welds are being advanced based on a revolving speed of a single weld bug (e.g., 500A), that single speed may be optimal for the weld process of one torch (e.g., 560A), but less than optimal for the other (e.g., 560B).

The present invention contemplates a simultaneous dual torch system and process for repeatably reproducing two weld passes of at least a certain minimum quality. FIG. 10 shows a weld bug 700 which may be used as one or more of the weld bugs 500 of the weld assembly 100 discussed above. Weld bug 700 may support a first torch 710 and a second torch 720. Each torch 710, 720 may include its own independent weld process equipment (e.g., power supply, weld feeder, etc.) for generating its own weld circuit. Furthermore, each independent power supply may be capable of generating and delivering various types of electrical circuit configurations or characteristics to/through the weld torch.

The contemplated dual torch process may include the step of choosing/designating one of the various types of well known electrical circuit weld configurations or characteristics (e.g., Surface Tension Transfer (STT), Cold Metal Transfer (CMT), Pulse, etc.) for/from each of the respective torch power supplies and or a weld bug speed in order to product an acceptable quality weld pass product from both torches. In one embodiment, for example, STT may be chosen for a first torch and pulse may be chosen for a second torch. In one embodiment CMT is chosen for a first torch and then pulse chosen for a second torch. In other embodiments, other combinations of the characteristics may be chosen in various orders. The contemplated process may also include the step of making adjustments to the certain electrical circuit configurations or characteristics and weld bug speed and then observing whether a weld quality of both passes is minimally acceptable. The contemplated process may also include the step of receiving as data and recording unique control circuit characteristics of each torch when acceptable weld performance is achieved for both passes.

The present invention also contemplates accessing the recorded data at a later date to identify in the data a pair of desired predetermined acceptable weld passes and the corresponding electrical circuit configurations or characteristics of the respective power supplies along with the bug speed which produced such weld passes. The present invention also contemplates sending a signal of the retrieved data to the respective torch power supplies to generate the electrical circuit configurations or characteristics in order to reproduce desired predetermined acceptable weld passes and sending a signal to the bug to reproduce the corresponding bug speed.

GrassHopper

Pipeline builders of very long stretches of pipe will sometimes perform what may be referred to in the industry as a tie-in weld. A tie-in weld may be a welding together of two very long pipe segments (e.g., a mile). Pipe segments that make up the pipeline will sometimes be coated with a material that is protective and or insulative. That coating will frequently cover all portions of the pipe except the ends of the pipe where it is to be welded to the adjacent pipe segment. Furthermore, the tie-in weld process involves a current path from the power supply (supply side), through the torch, through the weld, through some portion of the pipe, out of the pipe, and back to the power supply (ground side). To provide a current path from the pipe back to the power supply ground, an operator typically makes a connection (e.g., with a C-clamp) to an end of the pipe that is void of insulation. However, as mentioned above, the segments being tied-in may be very long and the nearest uninsulated portion of the pipe where an electrical connection (e.g., with a C-clamp) may be made may be impossible/impractical.

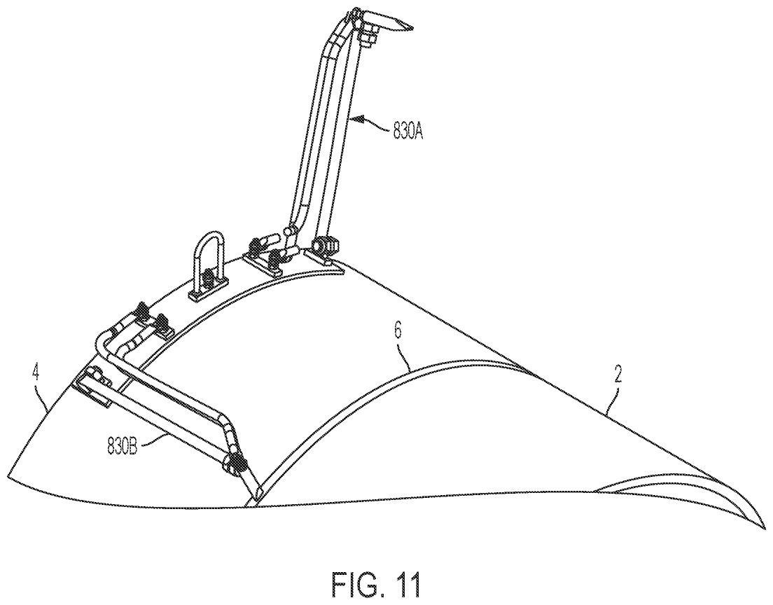

To solve this problem, weld operators use a grasshopper 800 such as the one shown in FIG. 11. FIG. 11 shows a perspective view of a weld equipment arrangement including Grasshopper 800. Grasshopper 800 allows an operator to create an electrical path between the pipe and the power supply ground. Grasshopper 800 essentially makes electrical contact/connection with pipes 2, 4 at the uninsulated gap 6. FIG. 11 shows a perspective view of pipe ends of pipes 2 and 4. Weld bugs 500A, 500B are also shown situated on pipes 2, 4 where they are required to be in order to traverse and weld at weld gap 6.

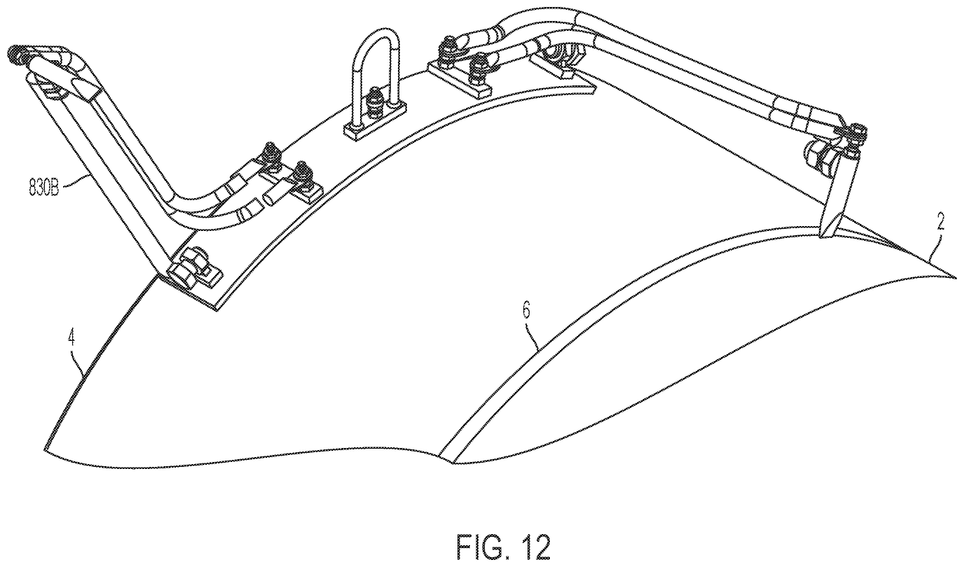

FIG. 12 shows a perspective image of details of grasshopper 800. A base 810 forms the backbone of grasshopper 800. Base 810 may be arcuate and have a curvature complementary to the curvature of the pipe on which it is being used. Base 810 may also include a permanent or electromagnet to secure base 810 to the pipe 2, 4. Grasshopper 800 may include at least one ground cable 820A, 820B. Ground cable 820A, 820B, may be a flexible electrically conducting cable. A first end of ground cable(s) 820A, 820B is connected to and extends from base 810. First ends of ground cables 820A, 820B are connected to base 810 via terminal bolts 840A, 840B. Terminal bolts 840A, 840B, may also accept a connector from the power supply ground. A second end of ground cable(s) 820A, 810B may be connected to a gap wedge 860A, 860B. Gap wedge 860A, 860B may extend into weld gap 6 and engage both end of pipes 2 and 4 so that current may pass from one of the ends of pipe 2 or 4, through ground cable 820A, 820B and to the power supply ground. At least one pivot arm(s) 830A, 830B also extend from base 810 via pivot connections 850A, 850B. A first end of pivot arm 830A, 830B may be connected to pivot connection 850A, 850B and a second end of pivot arm 830A, 830B may be connected to a second end of ground cable 820A, 820B (e.g., near or at where gap wedge 860A, 860B is connected). Pivot arm 830A, 830B may be rigid or load supporting and may support ground cable 820A, 820B such that gap wedge 860A, 860B may be pivoted relative to base 810 in a degree of freedom in and out of weld gap 6.

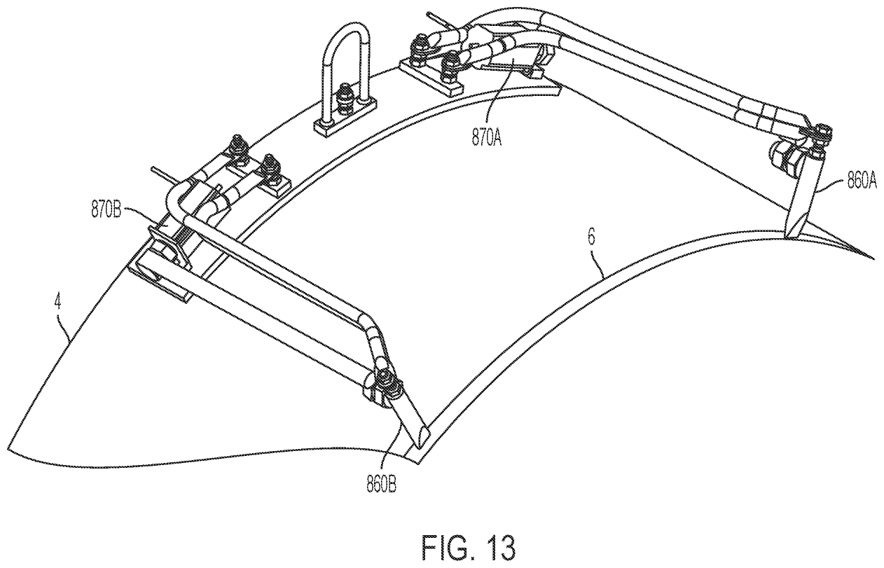

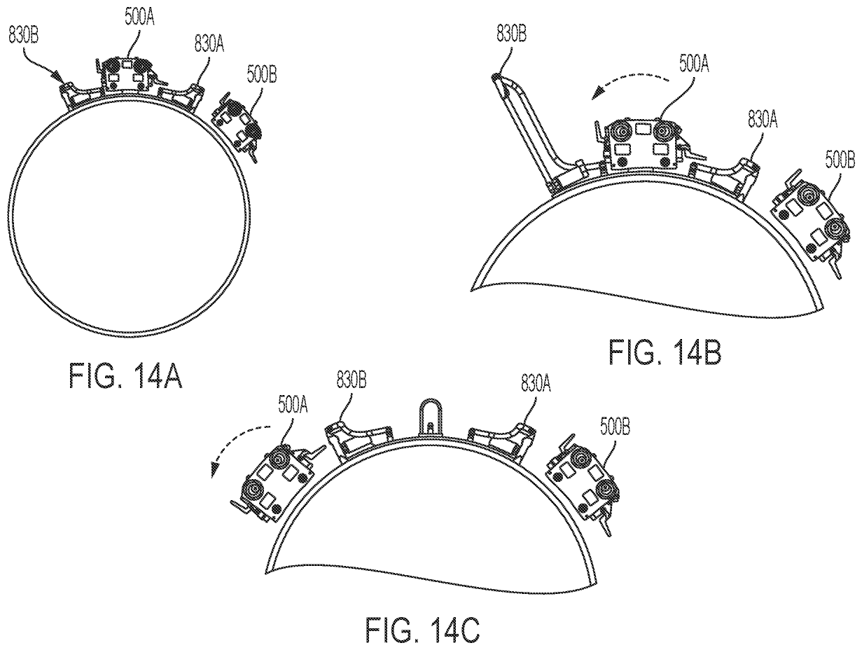

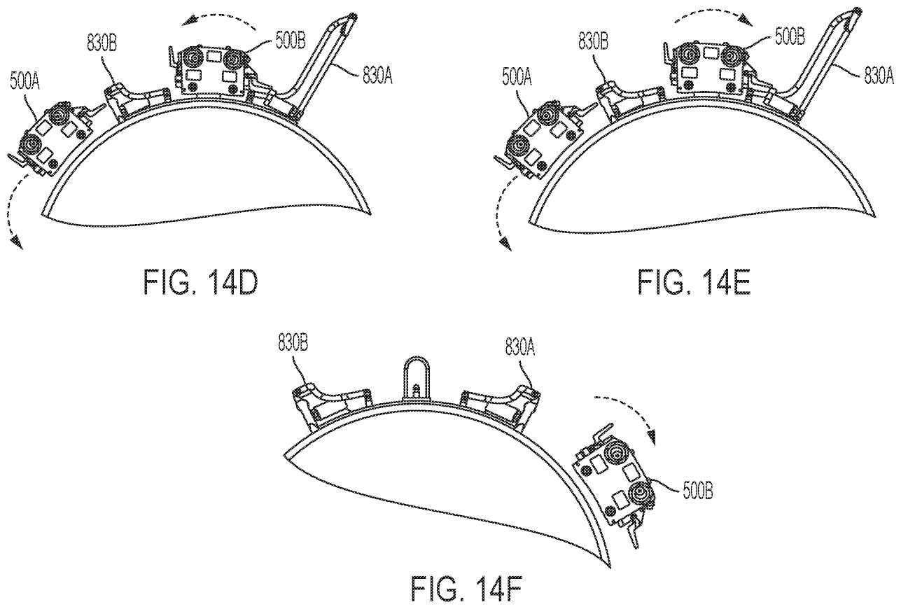

This pivot function of grasshopper 800 is necessary because the connection point of gap wedge 860A, 860B is in weld gap 6 in line with where torch(s) 710, 720 need to be to perform a pass in weld gap 6. In other words gap wedges 860A and 860B needs to be selectively pivoted out of the way of any oncoming weld bug 500A, 500B, or 700. At the same time since both terminal bolts 840A, 840B are electrically connected as one node, at least one gap wedge 860A, 860B, but only one gap wedge 860A, 860B need remain in weld gap 6 at any given time. In operation, the pivot arms 830A, 830B, are raised and lowered as the weld bugs 500A, 500B traverse the pipe 2, 4 as shown in FIG. 13 and FIG. 14. Specifically, FIG. 13 shows pivot arm 830A pivoted to and configured in in a raised position which supports gap wedge 860A and ground cable 820A out of the way of any oncoming weld bug 500A, 500B, or 700. Similarly, FIG. 14 shows pivot arm 830B pivoted to and configured in in a raised position which supports gap wedge 860B and ground cable 820B out of the way of any oncoming weld bug 500A, 500B, or 700.

When the weld assembly 100 of grapple welder 10 is connected to manipulator 200, weld procedures may be performed in a more highly automated manner which allows such procedures in more confined areas (e.g., a narrow ditch in which a pipeline is being installed). In other words, if it is desired to conduct a procedure in a space too small for an operator to perform a function or too small for the operator to perform the function safely, the function may be automated.

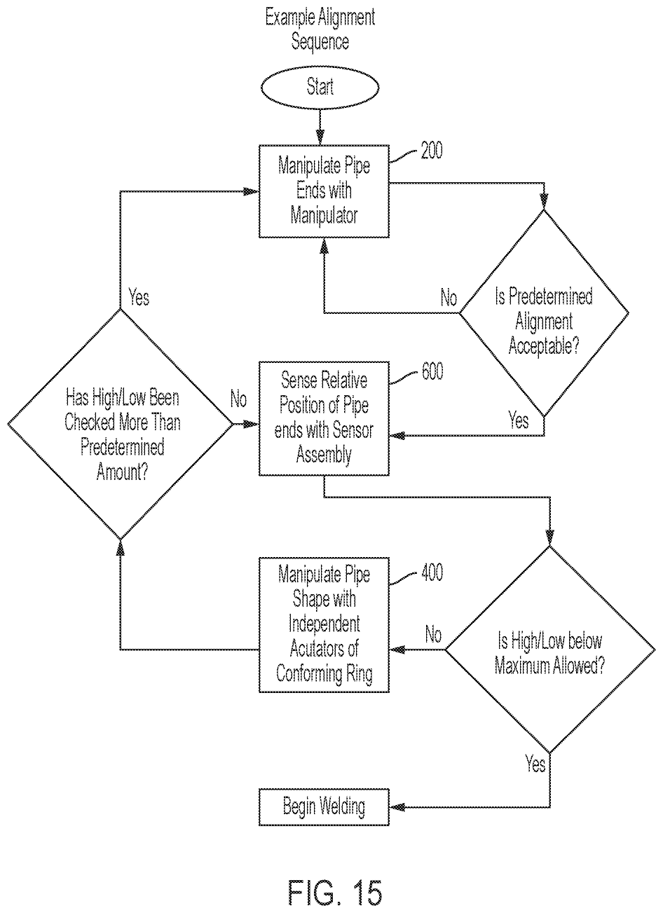

FIG. 15 shows grasshopper 800 further including a wedge actuator 870A, 870B. Wedge actuator 870A, 870B can be any kind of actuator (e.g., electric or hydraulic motor, electrical of hydraulic linear solenoid, etc.) that can be adapted to automatically raise (e.g., pivotally) an arm such as pivot arm 830A, 830B. Gap wedge 860A, 860B also need not have a pivot motion. Rather, gap wedge 860 may enter and leave contact with weld gap 6 in a linear and/or radial path. For example, in one embodiment, a tubular base (e.g., supported from grapple welder 10) could extend toward a central longitudinal axis of pipes 2, 4 and a gap wedge 860A, 860B could selectively extend linearly and telescopically from the tubular base between a first configuration in which the gap wedge 860A, 860B extends into contact with weld gap 6 and a second configuration in which gap wedge 860A, 860B is retracted out of weld gap 6 and out of the path of weld bugs 500A, 500B, or 700.

FIGS. 16A-16F illustrates an exemplary sequence of pivot arm 830A, 830B configurations relative to weld bug (e.g., 500A, 500B) pipe positions will now be discussed. FIG. 16A shows a weld bug 500A at the top (dead center) of pipe 4 and between gap wedge 860A and gap wedge 860B where both gap wedges 860A, 860B are in the downward configuration and engaged with wedge gap 6. FIG. 16A also shows weld bug 500B at about 2 o′clock and to the right of gap wedge 860B. Furthermore, both weld bugs 500A, 500B want to move counter clockwise. With the FIG. 16A bugs intending to move counter clockwise, FIG. 16B shows gap wedge 860B being raised out of the way of weld bug 500A which will be moving toward it. FIG, 16C shows weld bug 500A now past gap wedge 860B allowing gap wedge 860B to again take the downward engaged configuration. With weld bug 500B needing to move counter clockwise toward top dead center, FIG. 16D shows gap wedge 860B in the raised configuration and weld bug 500B counter clockwise moved past gap wedge 860B. As shown in FIG. 16E, with weld bug 500B at top dead center and needing to change direction and move back in the clockwise direction, gap wedge 860A may close for a moment or remain open in anticipation of weld bug 500B moving back past it in the clockwise direction. FIG. 16F shows how weld bug 500B has cleared gap wedge 830A and so gap wedge 830A can is not reconfigured back into the downwardly engaged position. At all times in the sequence, at least one of the gap wedges 860A and 860B are in the downward engaged position.

Various Contemplated Embodied Features

Sometimes it is necessary to change the angle of the torch during the welding process as the torch pivots back and forth in the plane of the weld (i.e., in the plane in which the circular pipe weld/gap is contained). In one embodiment of the claimed grapple welder 10, a control system maintains as close to constant heat input as possible to the weld while varying the head angle by adjusting the speed of travel of the bug and the power (e.g., current and voltage) to the torch.

In one embodiment, the weld operation is controlled remotely by tether or wirelessly since use of grapple welder 10 may leave limited space for an operator. Specifically, the remote controller (e.g., hand-held) may be used to control weld parameters such as bug speed, oscillation rate, head angle, wire feed rate, radial height of the torch tip off the weld.

In one embodiment, the heavy equipment vehicle which supports grapple welder 10 is fitted with mount, support, or platform for supporting auxiliaries necessary for the weld process such as gas tanks, power supplies, etc. Such accommodation by the grapple welder vehicle eliminates the need for a second vehicle for holding welding support equipment.

In one embodiment, sensed data from the welding process and/or bug travel or other motorized or electronic data may be wirelessly transmitted and stored/logged for use during the weld process or for improving future weld processes.

In one embodiment, data (e.g., distance profile and/or shape profile) sensed from sensors (e.g., sensing ring sensors) may be used to direct weld parameters (e.g., torch location, oscillation, amplitude, travel speed, wire feed speed, etc.) for positioning the torch and generating appropriate welds that conform to the sensed data.

In one embodiment, a line laser may be used to sense a 2-dimensional profile of the weld gap. In one embodiment the 2-dimensional line laser may be attached to a bug and swept 360 around the weld to form a 3D profile of weld gap 6. In one embodiment the line laser may be used to sense the shape of profile of the gap in order to direct the welder to fill the gap with weld material. In one embodiment the line laser may be used to sense a position of the weld relative to the gap or sense the structure of a weld generated by the weld process in order to inspect (i.e., for fill ratio, adaptation, etc.) the weld.

In one embodiment, data sensed (e.g., above mentioned sensed parameters) from the weld process and/or other operational processes is stored and added to previous such weld data to generate a historic database. In one embodiment, the historic data can be mined/processed to predict weld parameters which if performed again might result in a defect. In one embodiment, weld parameters can be compared to data from the historic data base in order to direct the weld process to adjust and/or avoid parameters that might generate a weld defect.

In one embodiment, a plurality of weld bugs or weld bugs with a plurality of torches may be used.

In one embodiment, a color camera may be used to remotely observe and/or inspect the weld during the weld process and/or after the weld is complete.

In one embodiment a pig is used to travel through the pipe to the weld and the pig includes sensor equipment to scan/inspect the pipe gap interface from the inside to generate a position profile of the gap in place of the external sensor assembly described above.

In one embodiment, the electronic computer control system of the present invention directs bug (after it is finished a weld pass at a first orbital position) to automatically change to a second orbital position to where it will begin a new pass. In one embodiment, the electronic control system also directs the torch to tilt into a position that would be convenient for an operator to perform a maintenance function on the torch (e.g., cut the feed wire) as the bug moves from the first orbital position to the second orbital position.

In one embodiment, a sensor is used to generate a first shape and/or position of an end of a first pipe to be welded and then used to generate a second shape and/or position of a second pipe to be welded. In one embodiment, the sensors generate the first and second shapes before the first and second pipes are placed together to form a gap. In one embodiment, data representing the first and second shapes are compared to generate an internal structural profile of the gap. In one embodiment data representing the structural profile is fed to the control system to direct the welder to perform a welding process in conformance with the structural profile.

In one embodiment, an electronic control system calibrates a position of a bug before welding begins. In one embodiment the calibration process involves recording a home position of the bug. In one embodiment, the electronic control system need only remember a single home position and is able to direct the complete positional weld sequence of the bug based on that single recorded and/tracked home position reference as the bug is directed to travel through a weld sequence. In one embodiment, the complete positional weld sequence involves directing the bug to travel along multiple passes.

In one embodiment, the welding assembly is a continuous circle that does not need to be opened and closed (e.g., like a clamshell) around a pipe to be welded since the application may be offshore where the pipe to be welded may be continuously feed through the continuous circular welder.

In one embodiment, a camera is fitted (e.g., on the bug) to the weld assembly and directed at the weld puddle so that an operator can observe the weld operation in progress and determine whether there are parameters (e.g., oscillation amplitude) which need adjusting (e.g., is the torch tip getting too close to the gap wall).

In one embodiment, a local enclosure is provided to protect the weld area from the elements. In one embodiment, the embodiment surrounds the weld area locally. In one embodiment, the local enclosure includes a gas evacuation passage for allowing gas to be removed from the weld area through the passage. In one embodiment, a camera (e.g., a color camera) may be positioned within the local enclosure to observe the weld operation near the weld tip including the weld puddle, the gap, and the torch tip.

In Operation

In operation, an operator operates a heavy equipment hydraulic vehicle 3 with the grapple welder 10 connected thereto via grapple connector 15. Fingers 242, 244, 262, 264 open independently of the weld assembly 100. Therefore, vehicle 3 can be used to place pipes in the ditch using manipulator 200, but without use of the weld assembly 100. In other words, an operator can use vehicle 3 to grab a pipe (e.g., 2) in the middle of the pipe and place it in the trench. After pipes are in the ditch, manipulator 200 of vehicle 3 can be used to grab the pipe at various parts of the pipe (e.g., 2) to better align the pipes for welding. When two adjacent pipes (e.g., 2, 4) are in the ditch/trench, and are sufficient aligned end to end, manipulator 200 may simultaneously grab both adjacent ends of pipes 2, 4 as described above. A more fine alignment may be performed via manipulator 200 as described herein above and in the description incorporated by reference. After some alignment, weld assembly 100 may be closed around weld gap 100. The above described sensor assembly 600 may be employed and deployed to determine a shape and position of the ends of the pipe relative to sensor assembly 600. A further alignment by manipulator 200 may then be performed and back and forth until sensing and alignment achieve an acceptable or predetermined relative positioning of the two pipe ends. Shoes 450A, 450B . . . 450E which now surrounds at least one of the pipe ends may be employed to extend, engage and reposition or reshape and end of the pipe (e.g., 2). Further, alignment adjust by manipulator 200 and further sensing may occur along with further conformation by confirmation ring 400 until a desired or predetermined acceptable relative positioning of the pipe ends is achieved (e.g., high low is below a maximum predetermined amount, where high low is the well known welding term in the industry). In one embodiment, a possible sequence of pipe manipulation operations may be shows as in FIG. Weld bug (e.g., 500A) may now initialize based on tracking of a single initial position and then perform a weld sequence of one or more passes. In operation, as weld bug 500A performs these passes, the weld bug may also utilize a motorized/automated grasshopper 800 using automatic sequencing similar to the sequencing described above.

Furthermore, as described herein, multiple bugs 500A, 500B may be employed in the weld process and each bug 500A, 500B may have one or more torches thereon. Furthermore, as described herein, a weld proves may employ a single bug (e.g., 500A) may multiple torches where each torch performs a weld based on an independent weld circuit supported by a respective independent power supply.

Miscellaneous

The embodiments of the present disclosure described above are intended to be examples only. The present disclosure may be embodied in other specific forms. Alterations, modifications and variations to the disclosure may be made without departing from the intended scope of the present disclosure. While the systems, devices and processes disclosed and shown herein may comprise a specific number of elements/components, the systems, devices and assemblies could be modified to include additional or fewer of such elements/components. For example, while any of the elements/components disclosed may be referenced as being singular, the embodiments disclosed herein could be modified to include a plurality of such elements/components. Selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

What is claimed is:

1. In combination, a pipe positioner and a welder for surrounding clutching, securing and manipulating a position of ends of pipes to be welded and welding the ends together, the combination comprising:
a pipe positioner, the pipe positioner including a pair of grapples mounted on a main beam, the grapples for grabbing and securing a pipe;
a welder, the welder including a welding bug including a torch, a bug rail on which the welding bug is guided, a deformation ring, and a sensor,
the deformation ring including radially extending shoes which forcefully engage an outer surface of a pipe to be welded,
the sensor including at least one radially inward directed sensor connected to a mount on the welder.
the welding bug rollably connected to the bug rail and traversing the bug rail in parallel arc with the welding area;
the deformation ring and sensor include at least one pivotable clamshell structure for selectively surrounding the pipe;
wherein the welder is mounted to the pipe positioner and the clamshell structure openable in concert with the grapples to receive the pipe ends and closable after closing of the grapples to surround a weld region of the pipe.

2. The combination of claim 1, wherein the mount is on the deforming ring and the sensor is a sensing ring including at least one sensor for sensing a position of a portion of the pipe relative to a position of the sensor or for sensing a position of the portion of the pipe to another portion of the pipe.

3. The combination of claim 2, wherein the welder includes a first configuration in which the sensing ring is proximate the deformation ring and a second configuration in which the sensing ring is axially extended to radially surround a weld gap between the pipe ends.

4. The combination of claim 3, wherein in first configuration, the sensing ring is retracted axially out of the way of an outer radial space of the welding bug, and in the second configuration when the sensing ring is extended, the sensing ring extends into the outer radial space of the welding bug.

5. The combination of claim 1, wherein the mount is on the welding bug and the sensor rotates around the pipe along with the welding bug.

6. The combination of claim 5, wherein the sensor directs a sensing beam longitudinally across a gap formed by the pipe ends to sense a profile of the gap.

7. The combination of claim 1, wherein the welder includes an actuator for transforming the clamshell structure between open and closed configurations.

8. The combination of claim 1, further including a control system for receiving a first set of position data sensed from a first pipe end and a second set of position data sensed from a second pipe end and comparing the first set of position data to the second set of position data to calculate a desired repositioning of at least one portion of one or both of the pipe ends toward better weld alignment.

9. The combination of claim 8, wherein the repositioning is performed by one or both of the grapples and the deformation ring.

10. The combination of claim 1, wherein the weld bug includes two torches and the two torches and the supply power from each torch has a different from the other pattern so that the weld bug creates two layer passes with different supply power characteristics.

11. The combination of claim 1, wherein an initial relative positioning of the pipe ends is performed by the grapples, then the position of the pipe ends is sensed and then a second positioning of the pipe ends is performed by at least one of the grapples and the deformation ring.

12. The combination of claim 1, wherein the grapples are 54 inches or less apart when the pipe ends are being manipulated.

13. The combination of claim 1, wherein an outermost width of the weld assembly is 15 inches or less.

14. A method of welding a pipe using the combination of claim 10, comprising: providing the combination of claim 1, determining by observation for a given pair of weld input characteristics, a best speed at which to run the weld bug in order to get an acceptable weld layer from both of the passes, keeping a recording of the weld bug speed and the power supply characteristics, repeating the prior two steps with different weld input characteristic combinations, using the kept record in the future to determining an acceptable speed for the weld bug when using a same or similar power input characteristics pairs for the two torches from the record.

15. An external orbital welder for automatically welding around an outer circumference of two pipe ends to be welded comprising: a guide rail for mounting around the pipe, a weld bug that is connected to and travels round the pipe on the rail, a first operable torch and a second operable torch on the weld bug, the first torch being independently supplied with power of different characteristics relative to the second torch so that each torch produces a weld pass corresponding to its weld power supply characteristics, each of the first and second torch including sensors for use in controlling its respective welding process, each torch also positioned sufficiently close to the other such that sensors of the first torch detect corresponding parameters from the process of the second torch and visa versa so that the proximity of the torches cause cross-interference between the two welding processes.

16. A method comprising the steps of: providing the apparatus of claim 1, determining by observation for a given pair of weld input characteristics, a best speed at which to run the weld bug in order to get an acceptable weld layer from both of the passes, keeping a recording of the weld bug speed and the power supply characteristics, repeating the prior two steps with different weld input characteristic combinations, using the kept record thereafter to determining an acceptable speed for the weld bug when using a same or similar power input characteristics pairs for the two torches from the record.
